(19) United States
(12) Patent Application Publication
(10) Pub. No.: US 2014/0234596 A1
(43) Pub. Date: Aug. 21, 2014

(54) Adhesive Structure of Optical Component, Manufacturing Method Thereof, and Image Output Device

(71) Applicant: Hitachi Media Electronics Co., Ltd., Yokohama-shi (JP)

(72) Inventors: Masayuki OKAMURA, Tokyo (JP); Hiroaki FURUICHI, Tokyo (JP); Teppei TANAKA, Yokohama (JP); Masahiko KAMESAWA, Yokohama (JP); Hitoshi SUGAWARA, Yokohama (JP)

(73) Assignee: Hitachi Media Electronics Co., Ltd., Yokohama-shi (JP)

(21) Appl. No.: 14/075,162

(22) Filed: Nov. 8, 2013

(30) Foreign Application Priority Data
Feb. 18, 2013 (JP) 2013-028549

(51) Int. Cl. C09J 9/00; G21K 5/08

(52) U.S. Cl. CPC C09J 9/00; G21K 5/08
USPC 428/212; 250/453.11

(57) ABSTRACT

An adhesive structure of an optical component includes a horizontal surface and a vertical surface. In a structure in which an optical component is adhered to a chassis having the horizontal surface and the vertical surface, an adhesive force per unit area of the vertical surface is higher than that per unit area of the horizontal surface.

### INCORPORATION BY REFERENCE

The present application claims priority of Japanese Patent Application Ser. No. 2013-028549, filed on Feb. 18, 2013, and disclosure of which is incorporated herein by reference thereto.

### BACKGROUND OF THE INVENTION

The present invention relates to an adhesive structure of an optical component, a manufacturing method thereof, and an image output device.

As a background art of this technical field, JP-A-2004-307547 (Patent Literature 1) is disclosed. This publication discloses that “a material to be treated includes one which transmits a photon, or once absorbs a photon and then causes wavelength shifting to radiate a photon different in energy. The materials to be treated and mediating materials are put in such a parallel arrangement that each surface of multiple contact interfaces between these materials is opposed to another, and a first contact interface of this parallel arrangement is irradiated with a photon, thus collectively achieving treatment for modifying the surfaces of the materials to be treated at every contact interface”. Further, JP-A-2006-274176 (Patent Literature 2) is disclosed. This publication discloses that “an adhesive property of the plastic surface can be improved by a method for modifying a plastic surface comprising irradiating a surface with vacuum UV light having a wavelength of 126 to 172 nm in an atmosphere of a gaseous oxidizing agent. Therefore, the adhesive property of the plastic surface can be improved by a simple method. In addition, the adhesive property can be homogeneously improved, when no etching treatment is conducted, without degradation of an inner part of plastics and without damaging material characteristics of the plastics (heat resistance, electric insulation, electric characteristics, and the like)”. In addition, JP-A-2008-214751 (Patent Literature 3) is disclosed. This publication discloses that “a surface-modified layer containing a metal hydroxide on a metal surface is formed by applying energy onto the surface of the metal. A surface-modified member having a surface-modified layer that contains a metal hydroxide and has a thickness of 5 μm or less is formed by applying this method to a metal member”.

### SUMMARY OF THE INVENTION

FIG. 1 illustrates one example of an assembly diagram of an optical pickup device. Optical components such as a laser and a mirror are fixed in appropriate positions on a chassis by an adhesive.

FIG. 2 illustrates as an example a schematic diagram of an RGB module that is an image output device. A system of fixing optical components on a chassis by an adhesive is adopted in the same manner as in an optical pickup device.

An RGB module is assumed to be mounted on a vehicle. Therefore, high reliability resistant to harsh environment of high temperature or high temperature and humidity is needed as compared to an existing RGB module.

As a method for making adhesive properties preferable, cleaning with a solution, corona discharge and plasma discharge, and also a surface treatment method through UV light are proposed. In Patent Literature 1, a method for collectively irradiating UV light onto a plurality of components is disclosed. In Patent Literature 2, a method for irradiating UV light to modify a plastic surface in an atmosphere of a gaseous oxidizing agent is disclosed. In Patent Literature 3, a device such that a surface-modified layer can be formed by applying energy to a metal surface is proposed.

In the same manner as in an optical pickup device, in an RGB module, optical components such as a mirror needs to be adhered and fixed in appropriate positions on a chassis by an adhesive. Adhesive strength is reduced also depending on variation in an application form, a position, and a supplied amount of an adhesive, and further a surface state also exerts a large influence on reduction in adhesive strength. In particular, when machining oil is adhered to a surface of an adhesion part, adhesive strength is reduced. Further, in the case of being made of plastics, some adherends originally have weak affinity with an adhesive. Consequently, although reliability in civilian goods is secured, adhesive strength is easy to be reduced and reliability may be insufficient under harsh environments such as vehicles.

A conceptual diagram illustrating a method for modifying a surface by UV light having a long wavelength is illustrated in FIG. 3 as one example of a conventional technique. A reference numeral 301 denotes a chassis, a reference numeral 302 denotes an optical component, and a reference numeral 303 denotes an adhesive. Conventionally, modification effects thereof are not sufficiently exerted by simple UV irradiation. That is, in a UV light source having a short wavelength, a modification effect is large; however, light is rapidly attenuated and a region that can be modified by light is small. On the other hand, as denoted by a reference numeral 304 of FIG. 3, in a UV light source having a long wavelength, a region that can be modified by light is large but a modification effect is small. In addition, a side surface cannot be sufficiently modified. Therefore, it is difficult to achieve sufficient adhesive strength by any UV light.

For example, the following matters are described with reference to examples of means for solving problems of the present invention.

(1) In a structure in which optical components are adhered to a chassis having a horizontal surface and a vertical surface, an adhesive force per unit area of the vertical surface is set to be higher than that per unit area of the horizontal surface.

(2) In an item of (1), both of the vertical surface and a bottom portion continuing to the vertical surface are adhered to a chassis.

(3) In a structure in which the optical components are adhered to the chassis having the horizontal surface and the vertical surface, first UV light having a long wavelength is irradiated and then second UV light having a short wavelength is irradiated. Through the process, an upper part of the vertical surface is surface-modified by both of the first and second UV light.

(4) In an item of (3), both of the vertical surface and a bottom portion continuing to the vertical surface are adhered to the chassis.

Further means and effects of the present invention will be apparent by the following embodiments.

In an optical pickup device and an RGB module, adhesive strength between optical components and chassis of an optical pickup and an image output device is made high and high reliability is achieved.

The other objects, features and advantages of the invention will become apparent from the following description of the embodiments of the invention taken in conjunction with the accompanying drawings.

### BRIEF DESCRIPTION OF DRAWINGS

FIG. 1 is an example of an assembly diagram illustrating an optical pickup device according to the present invention;

FIG. 2 is an example of an assembly diagram illustrating an RGB module according to the present invention;

FIG. 3 is a schematic cross-sectional diagram illustrating an adhesion part of a conventional optical component;

FIG. 4 is a schematic cross-sectional diagram illustrating an adhesion part of an optical component according to the present invention;

FIG. 5 illustrates wettability evaluation results about a wall surface of an adhesion part of an optical component according to the present invention; and

FIG. 6 illustrates adhesive strength evaluation results about an adhesion part of an optical component according to the present invention.

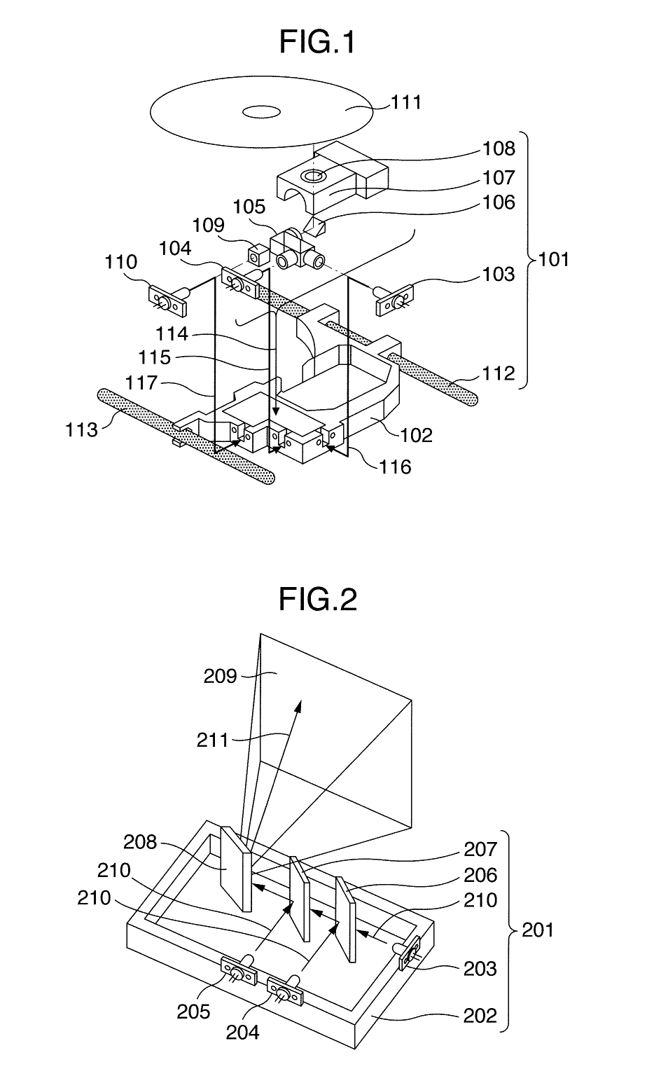

### DESCRIPTION OF THE EMBODIMENTS

Hereinafter, embodiments will be described.

### First Embodiment

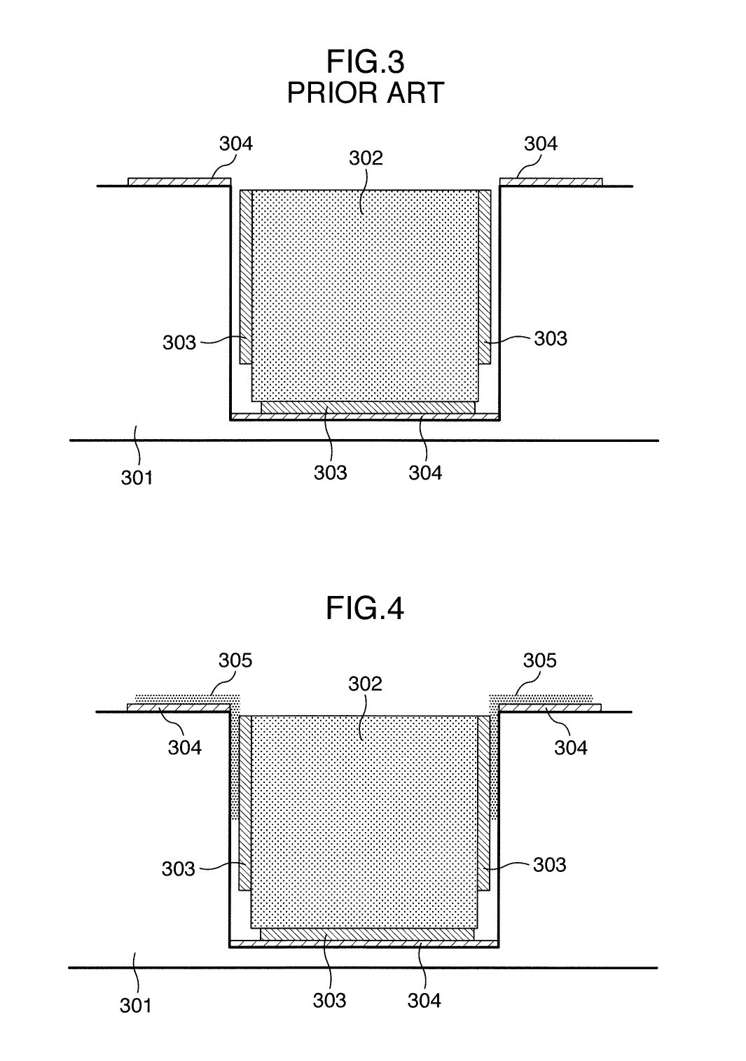

A first embodiment will be described with reference to FIGS. 4 to 6. The same reference numerals as those of FIG. 3 that illustrates a conventional example denote the same components.

FIG. 4 is a schematic cross-sectional diagram illustrating an adhesion part of a mirror (optical component) in an RGB module according to the first embodiment. Here, descriptions will be made with reference to an example where the optical component 302 is fixed on the chassis 301 by the adhesive 303.

First UV light is irradiated from an upper part of FIG. 4, for example, by a low-pressure mercury vapor lamp (wavelength: 254 nm). Although a wavelength of the first UV light is long, a surface modification and a cleaning effect are not so large. However, since a modification effect is maintained and energy of light is small, modification can be deeply performed regardless of a small effect. A surface modified by the first UV light is denoted by a reference numeral 304 of FIG. 4.

Second UV light a wavelength of which is shorter than that of the first UV light is further irradiated thereon. For example, an excimer lamp (wavelength: 172 nm) is used as the second UV light at this time. The second UV light having a short wavelength has no effect of deeply performing modification because of a short reaching depth; however, a modification effect in a portion near to a light source is larger than that of the first UV light. At this time, as one example, a region denoted by a reference numeral 305 of FIG. 4 is modified in a depth direction up to 3 mm from an upper part of a concave portion of FIG. 4. A main cause is that ozone is generated by irradiation of the second UV light to cause modification and, as denoted by a reference numeral 304 of FIG. 4, a modification region is modified up to not only the upper part but also a wall surface in a vertical direction.

In a structure in which optical components are adhered to a chassis having a horizontal surface and a vertical surface, the above process permits an adhesive force per unit area of the vertical surface to be set to be higher than that per unit area of the horizontal surface.

Here, an adhesive is coated and hardened on not only a bottom surface but also side surfaces. That is, the adhesive 303 is coated and hardened collectively on a concave bottom surface modified by the first UV light and wall surfaces modified by the first and second UV light. This feature improves adhesive strength. Further, an adhesion part has high adhesive strength and is adhered to three points at this time. Therefore, the adhesion part is stable also to displacement and has a high-reliability adhesive structure.

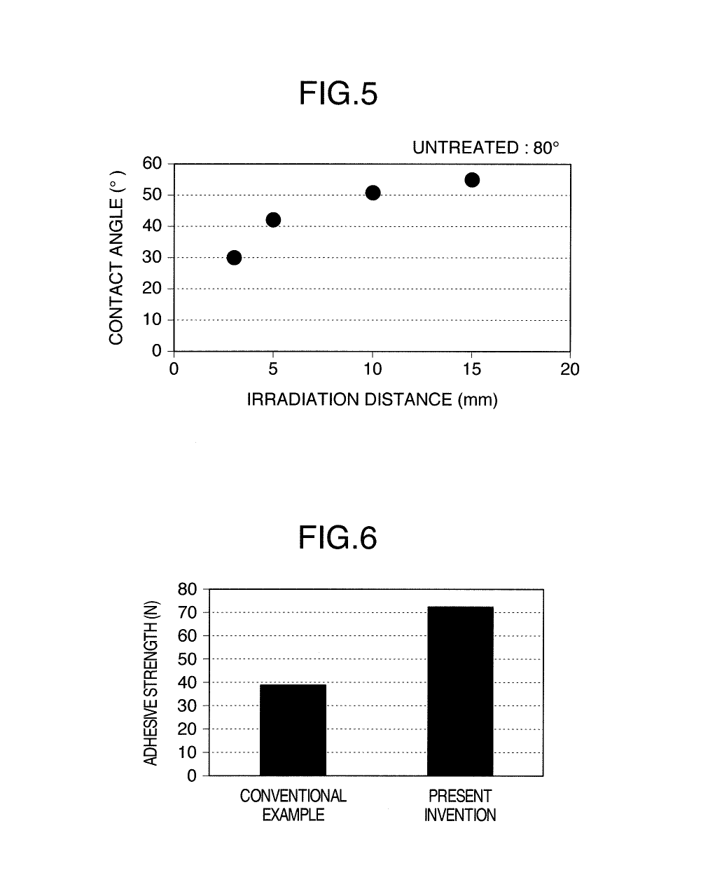

FIG. 5 illustrates a relationship between a wall surface distance, a contact angle as an evaluation result, and wettability to water on a wall surface of an adhesion part of the mirror (optical component) in the RGB module according to the first embodiment. It is understood that as an irradiation distance is longer, a contact angle of water is larger and an effect is smaller. Accordingly, it is confirmed that the wall surface has practically sufficient wettability up to 3 mm in a depth direction and a surface modification effect is exerted on the wall surface by the second UV light.

FIG. 6 illustrates adhesive strength evaluation results about an adhesion part of the mirror (optical component) in the RGB module according to the first embodiment. These are measurement results at the time when the chassis is made of Zn. In the present invention, an improvement in about twice adhesive strength as large as that of a conventional example is confirmed.

Further, a peeled surface thereof has a gradation state (not illustrated). An upper part of the vertical surface causes agglomeration peeling in which an adhesive itself is broken and, as it goes downward more, an interfacial peeling part is more increased. Therefore, adhesive strength at the upper part is higher than that at the lower part and an effect of the present invention is exerted.

In the case of the first embodiment, the metal chassis 301 is used. Therefore, when the first and second UV light are irradiated, stains of oil or the like on a surface are dissolved through irradiation of light and generation of ozone along with the irradiation, and a clean surface is obtained. Consequently, it is considered that since reduction in adhesive strength due to stains on a surface upon coating an adhesive is suppressed, the adhesive strength is improved.

In the present embodiment, a UV curing adhesive is used and even a thermo-setting adhesive can be applied. In addition, as materials of adhesives, epoxy resin, acrylic resin, and urethane resin can be applied to general adhesives.

In the present invention, descriptions are made with reference to a mirror as the optical component to be fixed on a chassis. The present embodiment can be applied to not only an optical pickup device and an RGB module but also optical components to be used in products having various chassis.

### Second Embodiment

A second embodiment differs the first embodiment in that the chassis 301 is made of plastics. Also in the present embodiment, adhesive strength is improved in the same manner as in the first embodiment. When the second embodiment is applied to a plastic chassis, adhesive strength is improved through not only decomposition of stains on a surface but also a modification effect of the plastic surface. Because of irradiation of the first and second UV light, both of decomposition of plastics by light and adsorption of ozone generated by light are caused on the plastic surface. Therefore, a carbonyl group, a carboxyl group, or a hydroxyl group being a functional group easily bonded to a surface is given. Consequently, wettability is improved, and molecules contained in an adhesive and the carbonyl groups react with each other. Therefore, adhesion becomes strong and adhesive strength is improved.

As described above, embodiments about an optical pickup device and an RGB module according to the present invention are described. The present invention is not limited to the above embodiments and, for example, can be applied also to a product as in a lens of a large-sized projector.

It should be further understood by those skilled in the art that although the foregoing description has been made on embodiments of the invention, the invention is not limited thereto and various changes and modifications may be made without departing from the spirit of the invention and the scope of the appended claims.

1. An adhesive structure of an optical component, comprising:
a horizontal surface; and
a vertical surface, wherein
in a structure in which an optical component is adhered to a chassis having the horizontal surface and the vertical surface, an adhesive force per unit area of the vertical surface is higher than that per unit area of the horizontal surface.

2. The adhesive structure of an optical component according to claim 1, wherein both of the vertical surface and a bottom portion continuing to the vertical surface are adhered to the chassis.

3. A method for manufacturing an optical component, the method comprising:
in a structure in which an optical component is adhered to a chassis having a horizontal surface and a vertical surface, irradiating first UV light having a long wavelength;
then irradiating second UV light having a short wavelength; and
surface-modifying an upper part of the vertical surface by both of the first UV light and the second UV light

4. The method according to claim 3, wherein both of the vertical surface and a bottom portion continuing to the vertical surface are adhered to the chassis.

5. An image output device having an adhesive structure of an optical component, comprising:
a horizontal surface; and
a vertical surface, wherein
in a structure in which an optical component is adhered to a chassis having the horizontal surface and the vertical surface, an adhesive force per unit area of the vertical surface is higher than that per unit area of the horizontal surface.

6. The image output device according to claim 5, wherein both of the vertical surface and a bottom portion continuing to the vertical surface are adhered to the chassis.
